(19) United States
(12) Patent Application Publication
(10) Pub. No.: US 2017/0303571 A1
(43) Pub. Date: Oct. 26, 2017

(54) System for Vacuum Distillation of Volatile Compounds

(71) Applicant: Adam Christopher Alden, Bakersfield, CA (US)

(72) Inventor: Adam Christopher Alden, Bakersfield, CA (US)

(21) Appl. No.: 15/498,199

(22) Filed: Apr. 26, 2017

Related U.S. Application Data
(60) Provisional application No. 62/327,520, filed on Apr. 26, 2016.

(51) Int. Cl. A23L 27/10; B01D 3/10

(52) U.S. Cl. CPC A23L 27/115; B01D 3/10; A23V 2002/00

(57) ABSTRACT

A system for vacuum distillation of volatile compounds imparts additive compounds to a consumable substance. This system includes a lid base, a vacuum port, a vacuum-gauge port, a distillation-flask port, a distillation flask, and a consumables container. The lid base engages the consumables container. The vacuum port and the vacuum gauge port traverse through the lid base. The distillation-flask port is adjacently connected to the lid base and the distillation flask engages the distillation-flask port. The vacuum port is connected to a vacuum source to depressurize the consumables container. A vacuum gauge hermetically engages the vacuum gauge port to monitor the pressure within the consumables container. Depressurizing the system lowers the temperature which the additive compound vaporizes. The additive compound condenses through the distillation-flask port and into the consumables container to impart the additive compound to the consumables within the consumables container.

The current application claims a priority to the U.S. Provisional Patent application Ser. No. 62/327,520 filed on Apr. 26, 2016.

### FIELD OF THE INVENTION

The present invention relates generally to a system designed to enrich or infuse consumables. More specifically, the present invention is specifically designed to enrich or infuse consumables under optimal conditions with flavoring compounds, mainly spice isolates, but can also be used to infuse vitamins, minerals, supplements, aromatics, etc. into or onto any consumable material

### BACKGROUND OF THE INVENTION

The present invention is a system for vacuum distillation of volatile compounds specifically designed to enrich or infuse consumables under optimal conditions with flavoring compounds, mainly spice isolates, but can also be used to infuse vitamins, minerals, supplements, aromatics, etc. into or onto any consumable material. Therefore, the present invention generates the possibility for creating the highest quality, delectable, and most nutritional consumables. The present invention can play a role in almost any cooking procedure enhancing the resulting consumable or food to its highest potential. The intended purpose of the present invention is to make any consumable imaginable a reality by providing the means to accomplish the delicate procedure involved under best conditions. The present invention is not intended to be used to cook food; however, the present invention is intended to provide a means of infusing or coating and enriching in the process of preparing or cooking consumables under optimal conditions in order to achieve the absolute best results possible. Some other factors may affect the resulting consumable such as the cooking apparatus used and/or the quality of the ingredients used.

### BRIEF DESCRIPTION OF THE DRAWINGS

FIG. 1 is a perspective view of the present invention;

FIG. 2 is a perspective view of the present invention, wherein the first stopper engages the gas-inlet port, the vacuum gauge engages the vacuum-gauge port, and the check valve engages the vacuum port.

FIG. 3 is a schematic diagram of the present invention, wherein the present invention comprises a temperature-monitoring device and a misting nozzle.

FIG. 4 is a schematic diagram of the present invention, wherein the

### DETAIL DESCRIPTIONS OF THE INVENTION

All illustrations of the drawings are for the purpose of describing selected versions of the present invention and are not intended to limit the scope of the present invention.

The present invention is a system for vacuum distillation of volatile compounds. The present invention is designed to enrich and infuse consumables with volatile flavor compounds, such as spice isolates; however, the present invention may also be used to infuse vitamins, minerals, aromatic compounds, or other additional nutritional supplements and fragrant compounds into any consumable. Consumables include, but are not limited to, crushed nuts; croutons; oregano; and French fried potatoes. The present invention is not intended to cook food, but to provide a means for coating, enriching, or infusing consumables under optimal conditions.

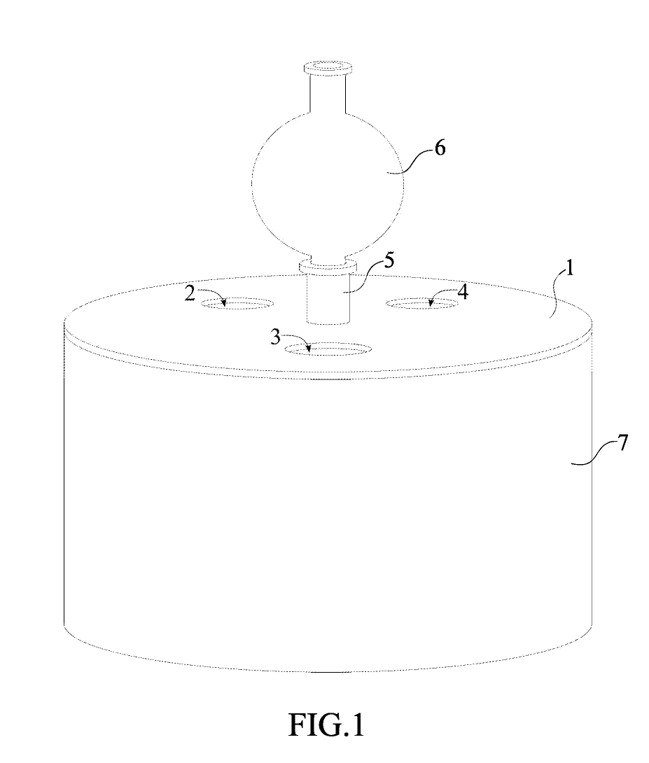

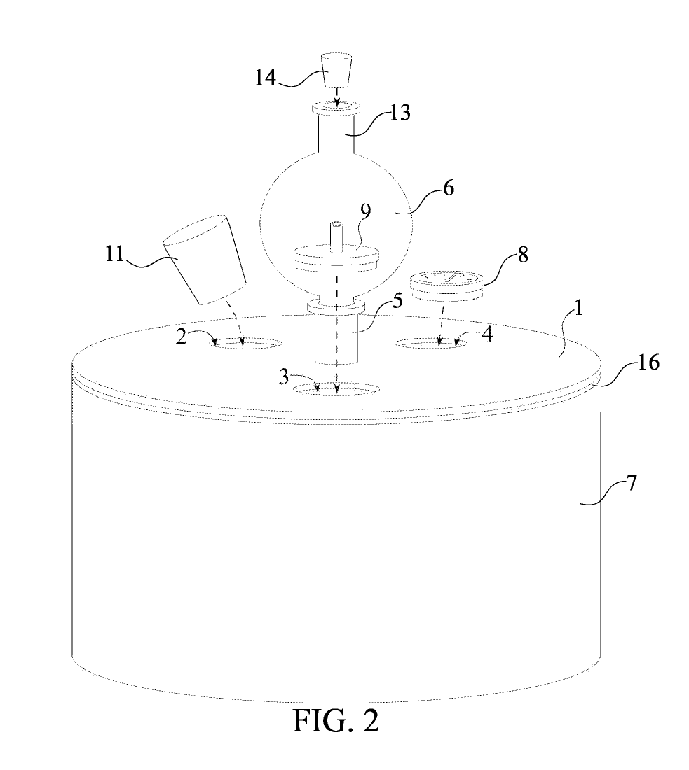

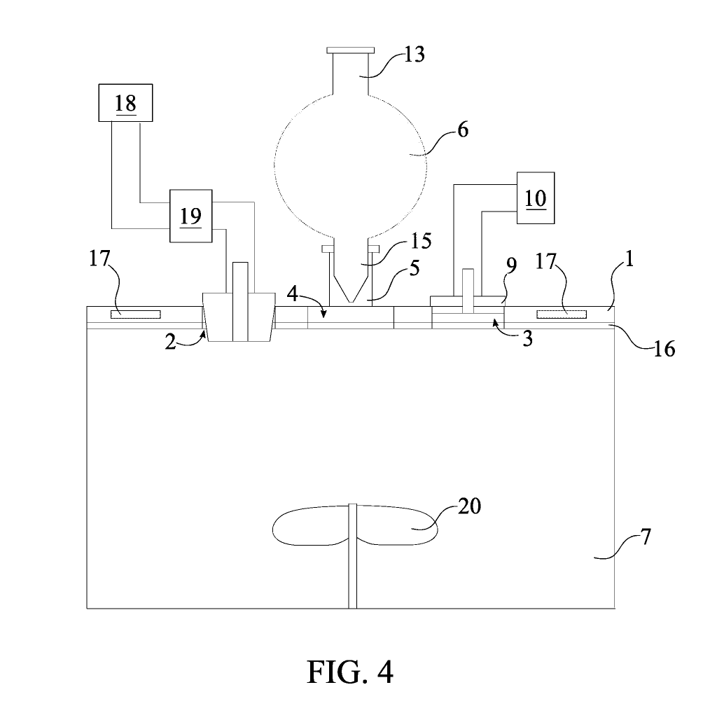

In accordance to FIG. 1, the present invention comprises a lid base 1, a gas-inlet port 2, a vacuum port 3, a vacuum-gauge port 4, a distillation-flask port 5, a distillation flask 6, and a consumables container 7. The lid base 1 supports the connections for an inlet-gas source 18 and a vacuum source 10, shown in FIG. 4, as well as, a vacuum gauge 8, shown in FIG. 2, to control and monitor the pressure within the consumables container 7. The gas-inlet port 2 traverses through the lid base 1 in order to receive fittings for fluid communication between the inlet-gas source 18 and the consumables container 7, as well as, stoppers if gas is not inlet into the consumables container 7. The vacuum port 3 similarly traverses through the lid base 1 to receive fittings for a vacuum source 10 to be placed on the additive compound in order to boil or sublimate the additive compound into a vapor phase, in order to impart the additive compound to the consumable within the consumables container 7. The vacuum-gauge port 4 similarly traverses through the lid base 1 to receive a vacuum gauge 8 to display the pressure within the consumable container as the present invention is implemented. The distillation-flask port 5 supports the distillation flask 6 to be mounted onto the lid base 1. The distillation-flask port 5 is centrally and adjacently connected to the lid base 1. The distillation flask 6 hermetically engages the distillation-flask port 5, as the distillation flask 6 holds the additive compound to be imparted to the consumable. The distillation flask 6 is oppositely positioned to the lid base 1 along the distillation-flask port 5. Within the distillation flask 6, the additive compound is converted to the vapor phase as pressure within the distillation flask 6 decreases due to the vacuum source 10, heat is applied to the distillation flask 6 to increase the temperature, or a combination of the decrease in pressure and an increase in temperature. The lid base 1 hermetically engages the consumables container 7, in order to create a seal. The consumables container 7 and the lid base 1 confine the consumables to be exposed to the vapor of the additive compound. The distillation flask 6 is preferred to be oriented away from the consumables container 7, in order to allow the user access to the distillation flask 6 as the lid base 1 engages the consumables container 7.

In accordance to the preferred embodiment of the present invention, the vacuum port 3, the gas-inlet port 2, and the vacuum-gauge port 4 are radially offset from the distillation-flask port 5, detailed in FIG. 1 and FIG. 2. Further, the vacuum port 3, the gas-inlet port 2, and the vacuum-gauge port 4 are evenly distributed about the distillation-flask port 5. This configuration allows the user to access each of the vacuum port 3, the gas-inlet port 2, the vacuum-gauge port 4, and the distillation flask 6 to be accessed individually, in order to adjust fittings, charge the distillation flask 6 with the additive compound, or monitor the pressure within the consumables container 7, without interference from another.

Further in accordance to the preferred embodiment, the present invention comprises a vacuum gauge 8, shown in FIG. 2. The vacuum gauge 8 is a fitting to monitor the pressure within the consumable container as a vacuum is applied. The vacuum gauge 8 hermetically engages the vacuum-gauge port 4 in order to seal the vacuum-gauge port 4 from the atmosphere. The vacuum gauge 8 is oriented away from the consumables container 7, in order for to allow the user to view the vacuum gauge 8 while the lid base 1 is engaged with the consumables container 7.

In some embodiments of the present invention, the present invention comprises a check valve 9 and a vacuum source 10, in accordance to FIG. 4. The check valve 9 prevents the loss of consumables within the consumable container from flowing into a vacuum hose in fluid communication between the vacuum source 10 and the check valve 9. The check valve 9 hermetically engages the vacuum port 3, in order to seal the vacuum port 3 from the atmosphere. The vacuum source 10 hermetically engages the check valve 9 in order to seal the check valve 9 from the atmosphere. The check valve 9 being positioned between the vacuum source 10 and the consumables container 7, in order for a vacuum to be created within the consumables container 7 when the vacuum source 10 is actuated and the lid base 1 engages the consumables container 7.

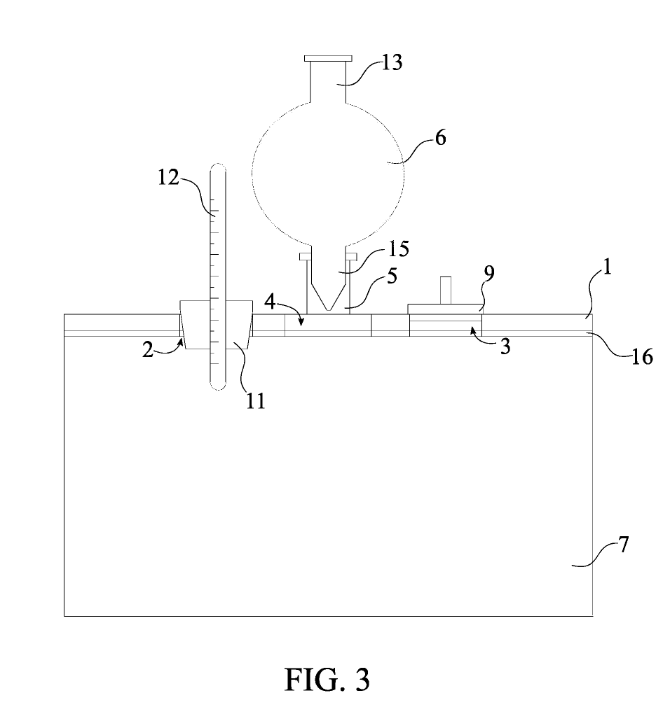

In some embodiments of the present invention, the present invention comprises a first stopper 11, shown in FIG. 2 and FIG. 3. The first stopper 11 hermetically engages the gas-inlet port 2 to seal the gas-inlet port 2 from the atmosphere. In a more specific embodiment of the present invention comprises a temperature-monitoring device 12. The temperature-monitoring device 12 is a device, such as a thermometer or temperature probe, used to discern the internal temperature of the consumables container 7 to allow the user to adjust the temperature to the optimal temperature for the reaction to vaporize the additive compound.

In accordance to the preferred embodiment of the present invention, the present invention comprises a compound-receiving port 13, detailed in FIG. 2, FIG. 3, and FIG. 4. The compound-receiving port 13 allows the user to introduce additional quantities of the additive compound into the distillation flask 6 before or during implementation of the present invention. The compound-receiving port 13 is integrated with the distillation flask 6. The compound-receiving port 13 is diametrically opposed to the distillation-flask port 5 about the distillation flask 6. The present invention is preferred to be implemented with oriented the distillation-flask port 5 horizontally, therefore, the distillation flask 6 is able to be charged with the additive compound during the implementation of the present invention.

In some embodiments of the present invention, the present invention comprises a misting nozzle 15, shown in FIG. 3 and FIG. 4. The misting nozzle 15 allows for the dispersal of any solid or liquid additive compounds remaining after the distillation flask 6 and the additive compounds comes to equilibrium. The misting nozzle 15 is mounted onto the distillation flask 6. The misting nozzle 15 is in fluid communication with the distillation flask 6 in order to disperse the remaining solid or liquid additive compound over the consumable within the consumables container 7.

In a more specific embodiment of the present invention, the present invention comprises a second stopper 14, shown in FIG. 2. The second stopper 14 hermetically engages the compound-receiving port 13 in order to seal the compound receiving port from the atmosphere and retain the additive compound within the distillation flask 6 during implementation of the present invention. The second stopper 14 allows for the insertion of a syringe to introduce the additive compound into the distillation flask 6, wherein the second stopper 14 is a rubber stopper. The rubber stopper allows for the insertion of additive compound into the distillation flask 6 without the introduction of ambient air from removing the second stopper 14.

In some embodiments of the present invention, the present invention comprises a vacuum seal 16, in accordance to FIG. 2, FIG. 3, and FIG. 4. The vacuum seal 16 hermitically seals the lid base 1 to the consumables container 7 when the vacuum source 10 is applied during implementation of the present invention. The vacuum seal 16 is perimetrically superimposed onto the lid base 1. The vacuum seal 16 is positioned between the lid base 1 and the consumables container 7, in order to seal the lid base 1 to the consumables container 7.

In accordance to the preferred embodiment of the present invention, the consumables container 7 is rotated about a central axis of the distillation-flask port 5 during implementation of the present invention. The rotation of the consumables container 7 agitates the additive compound as the additive compound resituates within the distillation flask 6 due to gravity. The agitation assists in distilling the additive compound into the vapor phase.

Due to the forces of rotation, some embodiments of the present invention comprise a plurality of balancing weights 17, in accordance to FIG. 4. The plurality of balancing weights 17 is integrated into lid base 1. The plurality of balancing weights 17 is distributed across the lid base 1, such that the center of mass of the lid base 1, the distillation-flask port 5, the distillation flask 6, the consumables container 7, and the vacuum gauge 8 is collinear with the axis of rotation, in order to provide a balanced rotation.

Further in accordance to the preferred embodiment of the present invention, the present invention comprises an inlet-gas source 18, shown in FIG. 4. The inlet-gas source 18 is used to re-pressurize the consumables container 7 to restore the internal pressure of the consumables container 7 to atmospheric pressure. While under negative pressure from the vacuum source 10, the second stopper 14 and the vacuum gauge 8, as well as, any other attached fittings are difficult to remove. The inlet-gas source 18 is in fluid communication with the gas-inlet port 2 to restore pressure to atmospheric pressure. Restoring the pressure within the consumables container 7 with the inlet gas allows the user to exchange, replace, or remove the second stopper 14, the vacuum gauge 8, as well as, any other attached fittings from the lid base 1. The inlet gas is preferred to be any inert gas such that the gas will not react with the additive compound.

In a more specific embodiment of the present invention, the present invention comprises an air filter 19, detailed in FIG. 4. The air filter 19 removes any particles or contaminates from the inlet gas, in order to maintain the purity of the additive compound and the consumable. The inlet-gas source 18 is in fluid communication with the gas-inlet port 2 through the air filter 19, in order to filter out any contaminates from the inlet gas stream.

In some other embodiments of the present invention, the present invention comprises an agitator 20, shown in FIG. 4. The agitator 20 is mounted within the consumables container 7. The agitator 20 mixes the consumables within the consumables container 7, in order for the additive compound to be evenly distributed throughout the consumables.

The lid base 1, the distillation-flask port 5, and the distillation flask 6 are preferred to be made from glass, stainless steel, or any other rigid food-safe material. The hermetic connections of the present invention may include food grade adhesives, greases, gaskets, or other appropriate methods to create an air-tight seal in order to prevent contamination of consumables within the consumables container 7 or the additive compound.

For the implementation of the present invention assembled as described, the user orients the consumables container 7, such that the distillation-flask port 5 and the distillation flask 6 are horizontal. The user then charges the distillation flask 6 with the selected additive compound. The user then rotates the consumables container 7 about the central axis of the distillation-flask port 5 as the vacuum source 10 is actuated. With the pressure decreasing within the consumables container 7 and the distillation flask 6, the boiling and sublimation temperatures of the additive compound decrease. Therefore, the quantity of the additive compound in the vapor phase increases. The quantity of additive compound is then drawn through the distillation-flask port 5 into the consumables container 7. Through the distillation-flask port 5 and the consumables container 7, the additive compound condenses onto the consumables within the consumables container 7, imparting the properties for the additive compound to the consumables. Once the additive compound is fully imparted to the consumables, the system is re-pressurized to atmospheric pressure using an inert gas from the inlet-gas source 18.

Although the invention has been explained in relation to its preferred embodiment, it is to be understood that many other possible modifications and variations can be made without departing from the spirit and scope of the invention as hereinafter claimed.

What is claimed is:

1. A system for vacuum distillation of volatile compounds comprises:
a lid base;
a gas-inlet port;
a vacuum port;
a vacuum-gauge port;
a distillation-flask port;
a distillation flask;
a consumables container;
the gas-inlet traversing through the lid base;
the vacuum port traversing through the lid base;
the vacuum-gauge port traversing through the lid base;
the distillation-flask port being centrally and adjacently connected to the lid base;
the distillation flask hermetically engaging the distillation-flask port;
the distillation flask being oppositely positioned to the lid base along the distillation-flask port; and
the lid base hermetically engaging the consumables container.

2. The system for vacuum distillation of volatile compounds, as claimed in claim 1, comprises:
the distillation flask being oriented away from the consumables container.

3. The system for vacuum distillation of volatile compounds, as claimed in claim 1, comprises:
the vacuum port, the gas-inlet port, and the vacuum-gauge port being radially offset from the distillation-flask port.

4. The system for vacuum distillation of volatile compounds, as claimed in claim 1, comprises:
the vacuum port, the gas-inlet port, and the vacuum-gauge port being evenly distributed about the distillation-flask port.

5. The system for vacuum distillation of volatile compounds, as claimed in claim 1, comprises:
a vacuum gauge;
the vacuum gauge hermetically engaging the vacuum-gauge port; and
the vacuum gauge being oriented away from the consumables container.

6. The system for vacuum distillation of volatile compounds, as claimed in claim 1, comprises:
a check valve; and
the check valve hermetically engaging the vacuum port.

7. The system for vacuum distillation of volatile compounds, as claimed in claim 6, comprises:
a vacuum source;
the vacuum source hermetically engaging the first check valve; and
the first check valve being positioned between the vacuum source and the consumables container.

8. The system for vacuum distillation of volatile compounds, as claimed in claim 1, comprises:
a first stopper; and
the first stopper hermetically engaging the gas-inlet port.

9. The system for vacuum distillation of volatile compounds, as claimed in claim 8, comprises:
a temperature-monitoring device; and
the temperature-monitoring device traversing through the first stopper.

10. The system for vacuum distillation of volatile compounds, as claimed in claim 1, comprises:
a compound-receiving port;
the compound-receiving port being integrated with the distillation flask; and
the compound-receiving port being diametrically opposed to the distillation-flask port about the distillation flask.

11. The system for vacuum distillation of volatile compounds, as claimed in claim 10, comprises:
a second stopper; and
the second stopper hermetically engaging the compound-receiving port.

12. The system for vacuum distillation of volatile compounds, as claimed in claim 1, comprises:
a misting nozzle;
the misting nozzle being mounted onto the distillation flask; and
the misting nozzle being in fluid communication with the distillation flask.

13. The system for vacuum distillation of volatile compounds, as claimed in claim 1, comprises:
a vacuum seal;
the vacuum seal being perimetrically superimposed onto the lid base; and
the vacuum seal being positioned between the lid base and the consumables container.

14. The system for vacuum distillation of volatile compounds, as claimed in claim 1, comprises:
a plurality of balancing weights;
the plurality of balancing weights being integrated into the lid base; and
the plurality of balancing weights being distributed across the lid base.

15. The system for vacuum distillation of volatile compounds, as claimed in claim 1, comprises:
an inlet-gas source; and
the inlet-gas source being in fluid communication with the gas-inlet port.

16. The system for vacuum distillation of volatile compounds, as claimed in claim 15, comprises:
an air filter; and
the inlet-gas source being in fluid communication with the gas-inlet port through the air filter.

17. The system for vacuum distillation of volatile compounds, as claimed in claim 1, comprises:
an agitator; and
the agitator being mounted within the consumables container.
